(19) United States
(12) Patent Application Publication
(10) Pub. No.: US 2004/0237913 A1
(43) Pub. Date: Dec. 2, 2004

(54) Nanninga diesel

(76) Inventor: Jeffrey Karl Nanninga, Grandville, MI (US)

Correspondence Address: Jeffrey Karl Nanninga, 2742 Carla S.W., Grandville, MI, 49418, US

(21) Appl. No.: 10/819,829

(22) Filed: Apr. 7, 2004

Related U.S. Application Data
(60) Provisional application No. 60/474,054, filed on May 30, 2003.

(51) Int. Cl. F02B 75/28

(52) U.S. Cl. 123/51 R

(57) ABSTRACT

The differences in the Nanninga Diesel, as pertaining to any other diesel engine, is The lack of cylinder heads, valves, valve operating mechanisms and camshafts. What is Unique about the Nanninga Diesel is the use of 4 crankshafts, 32 pistons and 16 cylinders In a box configuration. The pistons uncover ports for intake and exhaust, leaving no need For valves, a blower pushes the air through the cylinders and supercharges. The Gear Reduction from the 4 crankshaft gears to the output gear will increase torque by about 7 Times. There are 4 cylinders firing at exactly the same time, one in each row of banks. This puts 2 impulses on each crankshaft during one time of injection. All cylinders fire in One revolution of the crankshafts. To my knowledge a diesel engine of this design has Never been built.

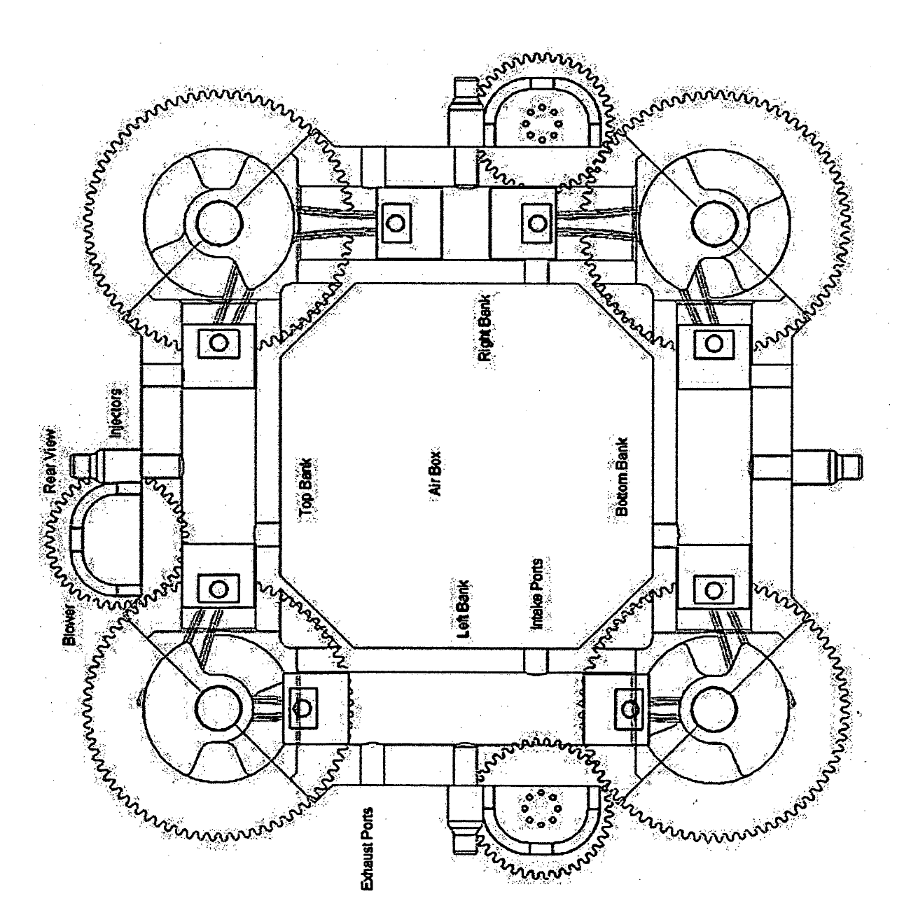

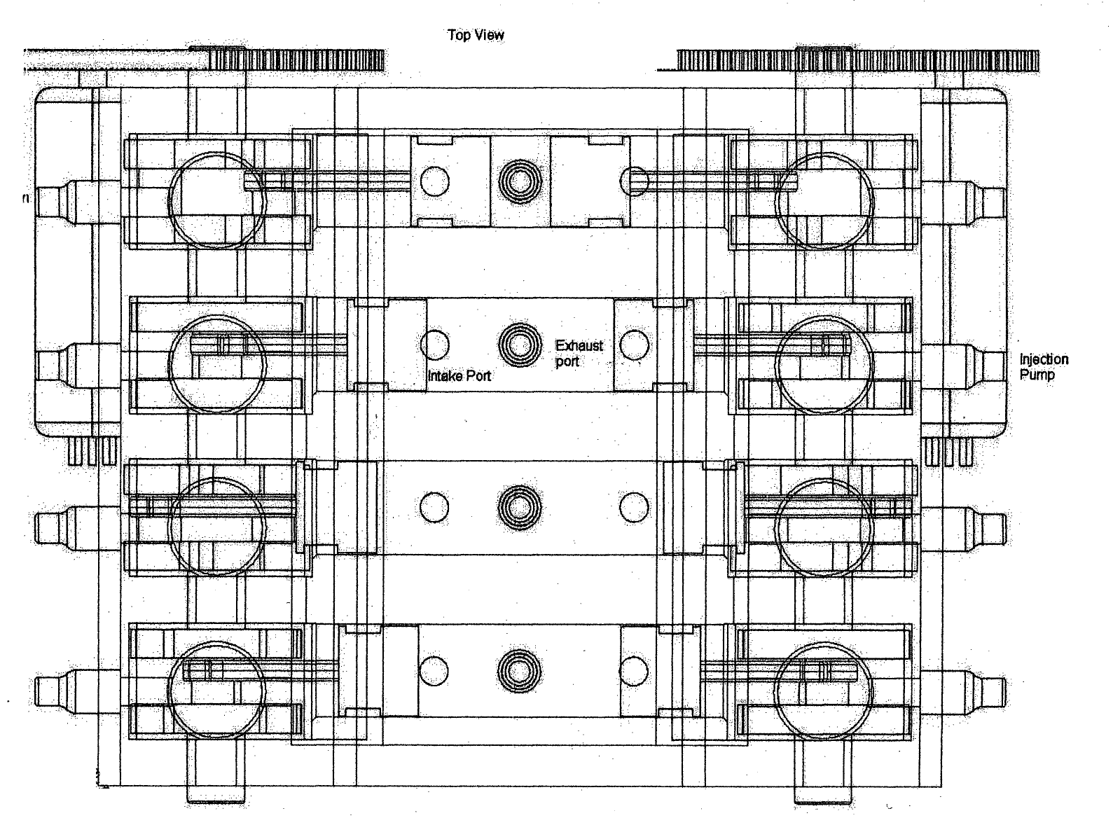

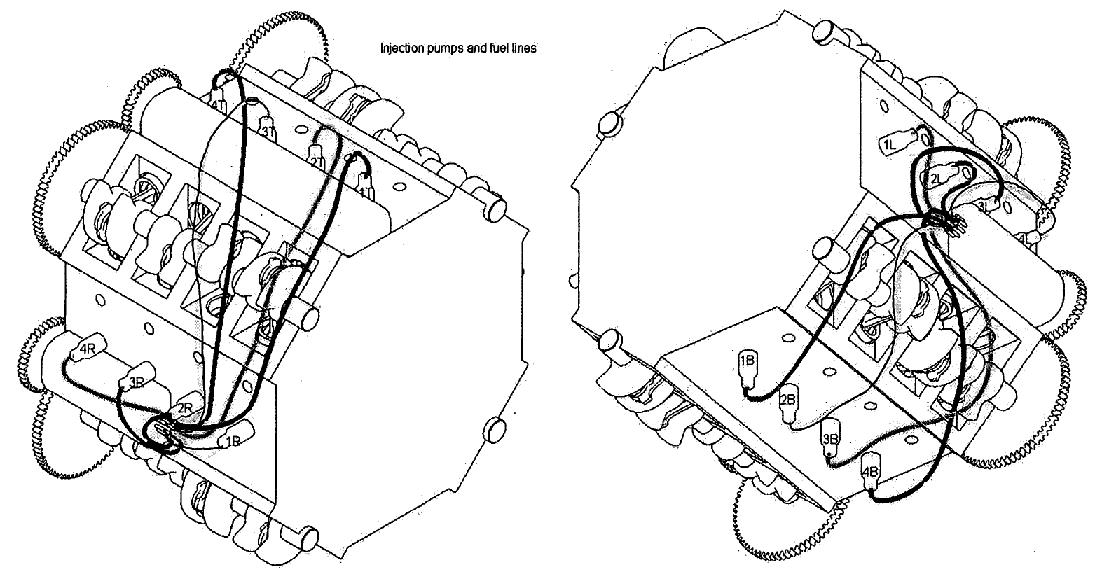

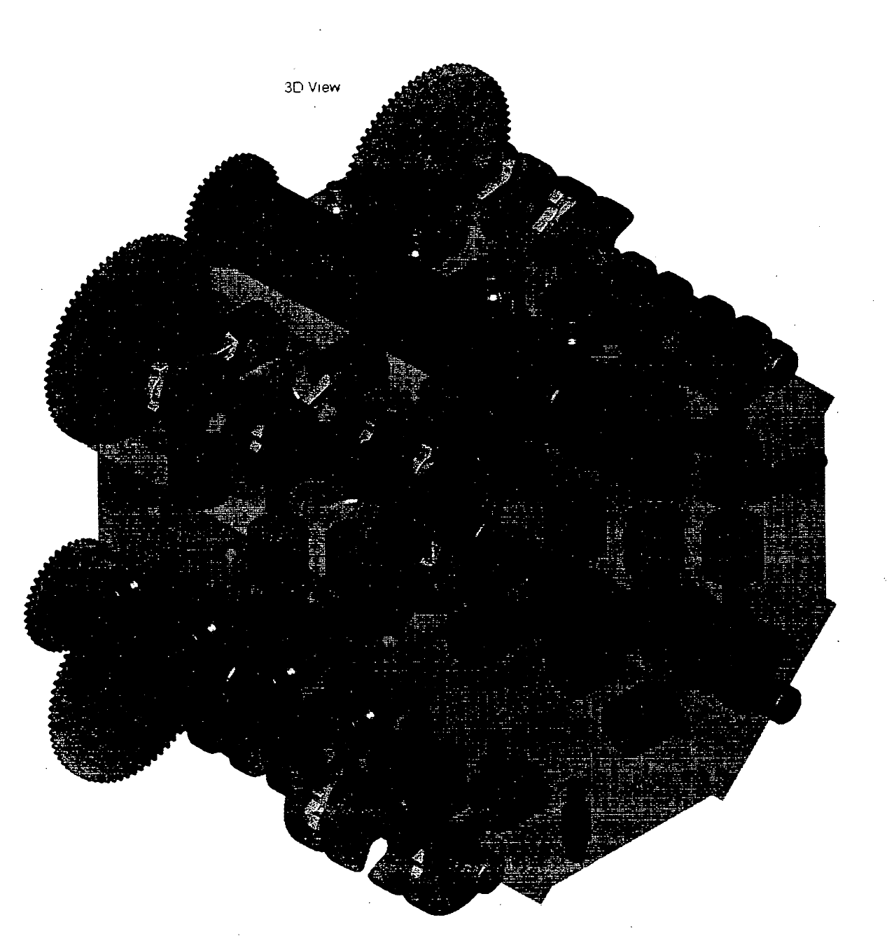

### FIELD OF INVENTION

Pertaining to the field of Heavy Duty Diesel Engines.

### SUMMARY OF THE INVENTION

A diesel engine that has never been built. It has no cylinder Heads, valves, valve train, or camshafts to rob an engine of Horsepower. This engine would have the ability to produce More horsepower than any engine ever designed.

Drawing 1 of 4: This view is shown from the rear of the engine. The gear train is visible.

The center gear, which is the output gear, has been left out for visibility. All four crankshaft gears are meshed with the output gear. The gear ratio Difference between the crank gears (smaller), and the much larger output Gear would greatly increase horsepower and torque. As you can see all Pistons compress the air in the cylinder head to head, with an injector Located directly between them.

Drawing 2 of 4: This view is shown from the top of the engine. The gear driven blower (left out of this picture for visibility) is located on top of the engine Above the intake ports. The pistons uncover the intake and exhaust ports At different times to allow forced air from the blower's air box to enter The cylinder. When both ports are closed compression is accomplished, Then power. Exhaust occurs when the piston uncovers the exhaust port And scavenging air forces spent exhaust gases out of the engine to Exhaust manifolds (not shown). Top view also allows the view of 2 gear Driven fuel injection pumps.

Drawing 3 of 4: This is a more solid view of the engine, without oil pans, to better view The crankshafts. The purpose of this view is to clarify the fuel injection Pumps and lines. Notice the four different colors of the injection lines. Each injection pump has 2 lines of the same color located 180 degrees Away from each other. This is a 2 stroke diesel engine. Four cylinders Fire at exactly the same time, with all 16 cylinders firing in one Revolution of all the crankshafts. Therefore with 2 injection pumps, each Controlling 2 cylinders at the same time, this can be accomplished. The Cylinders are staggered throughout the engine, all four crankshafts Receive 2 power impulses on it in two separate locations, each time four Cylinders fire. A set of four cylinders will fire each 90 degrees of engine Rotation. The firing order of this engine is as follows:

Note: #1 cylinder is viewed from the rear of the engine as #1 left.

T.D.C. (#1 cylinder on left)

1 left, 3 bottom, 4 right, 2 top

90 degrees after top dead center

3 left, 4 bottom, 2 right, 1 top

180 degrees after top dead center

4 left, 2 bottom, 1 right, 3 top

90 degrees before top dead center

2 left, 1 bottom, 3 right, 4 top

Then the cycle repeats itself. All accomplished in one revolution of all four crankshafts Simultaneously.

Drawing 4 of 4: This is a skeleton view of the engine. It shows all 4 crankshafts, all 32 Pistons and how they are arranged head to head. This view also gives an Excellent view of the blower, located on top of the engine and how it's Gear driven. You can also see the injectors and there location.

### DESCRIPTION OF INVENTION

This engine is a 2 stroke diesel with 16 cylinders, 32 pistons, 2 Fuel injection pumps, 4 crankshafts and a blower. Without any Valves, pushrods or camshafts, to rob horsepower. Along with 2 power impulses on each crankshaft simultaneously, 4 times Per crankshaft revolution and a massive gear ratio reduction to The output gear, the horsepower and torque would be Incredible. The fuel system could be managed in two separate Ways: The first, shown in the pictures supplied, is of the Mechanical type. The second way would be to have a common Fuel rail, a supply lift pump and electronic fuel injectors, Controlled by a computer. These engines could be designed With a varying number of cylinders of different sizes for Various applications. There purpose would range from ships, Trains, very large heavy machinery and equipment, to versions Small enough for over the road semi trucks, busses, etc. One Engine can produce enough horsepower to do the work of Several engines.

1. What I claim as my invention is a box engine, unlike any engine I believe to have Been built. With four crankshafts, 32 pistons, 16 cylinders, 2 fuel injection Pumps and a blower. With a lack of cylinder heads, valves, a camshaft or valve Train.
